(19) United States
(12) Patent Application Publication
(10) Pub. No.: US 2025/0392108 A1
(43) Pub. Date: Dec. 25, 2025

(54) ELECTRICAL BOX COVER

(71) Applicant: Hubbell Incorporated, Shelton, CT (US)

(72) Inventors: Krzysztof W. Korcz, Granger, IN (US); Victor Beristany, South Bend, IN (US); Krishna C. Patel, Granger, IN (US)

(21) Appl. No.: 19/242,183

(22) Filed: Jun. 18, 2025

Related U.S. Application Data
(60) Provisional application No. 63/662,578, filed on Jun. 21, 2024.

(51) Int. Cl. H02G 3/18; H02G 3/08; H02G 3/12; H02G 3/14

(52) U.S. Cl. CPC H02G 3/18; H02G 3/081; H02G 3/12; H02G 3/14

(57) ABSTRACT

A cover plate for an electrical box includes a base plate and a plurality of side walls extending from the base plate. The plurality of side walls at least partially define a central opening. The plurality of side walls including a curvilinear wall and a set of opposing rectilinear walls. A first set of mounting ears extends from the plurality of side walls into the central opening. The first set of mounting ears are positioned to receive an electrical device in a first orientation. A second set of mounting ears extend from the plurality of side walls into the central opening. The second set of mounting ears are positioned to receive an electrical device in a second orientation.

### RELATED APPLICATION(S)

This application is based on U.S. Provisional application Ser. No. 63/662,578, filed Jun. 21, 2024, the disclosure of which is incorporated herein by reference in its entirety and to which priority is claimed.

### FIELD

The present disclosure relates to a mounting plate for connecting an electrical device to a junction box.

### BACKGROUND

Electrical boxes are commonly used in the residential and commercial building industry. Electrical boxes are typically mounted in walls or ceilings and provide an access point to main power supply wiring for an electrical device. These devices can include power outlets, light switches, ceiling fans, and the like.

The electrical boxes are often mounted in a variety of positions and locations in the wall or ceiling. An electrical box is typically attached to the stud or other support structure by nails, screws or other fasteners. In new construction, the electrical box is attached to the building stud with the open front face of the electrical box positioned so that the outer face of the drywall or paneling is essentially flush with the outer edge of the electrical box. In some forms of construction, the stud or other structure does not allow proper orientation of the electrical box so that the open end of the electrical box is recessed with respect to the outer surface of the wall when the wall is installed and finished.

Renovating old construction also can create difficulties in positioning the electrical box with respect to the outer surface of the wall. New wall board or paneling can be applied over existing walls so that the original electrical box is recessed within the wall and is not easily moved or relocated. The recessed electrical box results in the electrical device being recessed with respect to the wall and is not easily accessible.

### SUMMARY

Certain implementations include a cover plate for an electrical box. The cover plate includes a base plate and a plurality of side walls extending from the base plate. The plurality of side walls at least partially define a central opening. The plurality of side walls including a curvilinear wall and a set of opposing rectilinear walls. A first set of mounting ears extends from the plurality of side walls into the central opening. The first set of mounting ears are positioned to receive an electrical device in a first orientation. A second set of mounting ears extend from the plurality of side walls into the central opening. The second set of mounting ears are positioned to receive an electrical device in a second orientation.

In certain configurations a cover plate for an electrical box includes a base plate and a plurality of side walls extending from the base plate. The plurality of side walls at least partially define a central opening. The plurality of side walls including a set of opposing curvilinear walls and a set of opposing rectilinear walls. A first set of mounting ears extends from the plurality of side walls into the central opening. The first set of mounting ears are positioned to receive an electrical device in a first orientation. A second set of mounting ears extend from the plurality of side walls into the central opening. The second set of mounting ears are positioned to receive an electrical device in a second orientation. A masonry bracket is connected to one of the side walls.

In certain configurations a bracket for securing an electrical box cover to a support surface includes a body, a leg extending from the body, a flange extending form the leg, a pair of lower spring members extending from the body, and an upper spring member extending from the body.

Certain implementations include a mud ring assembly for supporting an electrical device. The mud ring assembly includes a cover having a base plate, a plurality of side walls extending from the base plate and at least partially defining a central opening. The plurality of side walls including a set of curvilinear walls and a set of rectilinear walls. An adjustable ring is positioned within the cover and movable within the cover between a retracted position and an extended position. A drive member is operatively coupled to the cover such that rotation of the drive member causes the ring to move between the retracted position and the extended position.

### BRIEF DESCRIPTION OF THE DRAWINGS

The aspects and features of various exemplary embodiments will be more apparent from the description of those exemplary embodiments taken with reference to the accompanying drawings.

FIG. 1 is a front perspective view of an outlet cover.

FIG. 2 is a rear perspective view of the outlet cover of FIG. 1.

FIG. 3 is a front view of the outlet cover of FIG. 1.

FIG. 4 is a front perspective view of another outlet cover.

FIG. 5 is a front view of the outlet cover of FIG. 4.

FIG. 6 is a front perspective view of another outlet cover.

FIG. 7 is a front view of the outlet cover of FIG. 6.

FIG. 8 is a front perspective view of another outlet cover.

FIG. 9 is a front view of the outlet cover of FIG. 8.

FIG. 10 is a front perspective view of another outlet cover.

FIG. 11 is a front view of the outlet cover of FIG. 10.

FIG. 12 is a perspective view of the outlet cover of FIG. 10 connected to an electrical box and a light fixture.

FIG. 13 is a front perspective view of another outlet cover.

FIG. 14 is a front view of the outlet cover of FIG. 13.

FIG. 15 is a front perspective view of another outlet cover.

FIG. 16 is a front view of the outlet cover of FIG. 15.

FIG. 17 is a front perspective view of an outlet cover and masonry bracket.

FIG. 18 is a front perspective view of the bracket of FIG. 17.

FIG. 19 is a front view of the bracket of FIG. 18.

FIG. 20 is a top view of the bracket of FIG. 17.

FIG. 21 is a side view of the bracket of FIG. 17.

FIG. 22 is a front perspective view of the cover and bracket of FIG. 17 and support surface.

FIG. 23 is a front perspective view of the cover and bracket of FIG. 17 installed in the support surface.

FIG. 24 is a top view of the cover and bracket of FIG. 17 installed in the support surface.

FIG. 25 is top perspective view of a cover and adjustable ring connected to an electrical box.

FIG. 26 is a front perspective view of the cover of FIG. 25.

FIG. 27 is a front view of the cover of FIG. 25.

FIG. 28 is a front perspective view of the adjustable ring of FIG. 25.

FIG. 29 is a rear perspective view of the adjustable ring of FIG. 25.

FIG. 30 is a side view of the adjustable ring of FIG. 25.

FIG. 31 an exploded view of the ring of FIG. 25.

FIG. 32 is a top perspective view of the cover and ring with the ring in the extended position.

FIG. 33 is a bottom perspective view of the cover and ring in FIG. 32.

### DETAILED DESCRIPTION OF EXEMPLARY EMBODIMENTS

Various implementations are directed to a mounting plate for connection to an electrical box such as a junction box. Plaster rings, extension rings, and extenders, commonly known as mud rings, can be attached to the box prior to the installation of a surface material, such as sheet rock, wall board, ceiling panels, etc. Other mounting plates and adapters can also be connected to the electrical box to provide an appropriate mounting surface for the device and to cover any exposed portions of the junction box. In this manner, full coverage of any electrical connections or conductors can be achieved.

During a home or building renovation or remodel, property owners often decide to update the electrical apparatuses or fixtures in particular rooms. This might include replacing old light switches, outlets, or thermostats with new, more modern versions. One common issue that arises during this process is the incompatibility between the shape of the existing junction box installed behind the wall and the new device ring or fixture plate. Junction boxes come in various shapes and sizes, and it is not uncommon for the shape of a newly selected fixture to differ from the shape of the existing junction box. The task of removing the old junction box and installing a new one that fits the new fixture can be tedious, time-consuming, and expensive. To avoid these difficulties, an adapter can be used to bridge the gap between different shaped junction boxes and fixtures, simplifying the installation process.

For instance, a property owner may want to replace an old rectangular thermostat with a new circular one during a remodel. If the existing junction box is square-shaped, and the new thermostat requires a circular junction box for the best aesthetic appearance, this presents a challenge. The solution in such cases is to use a square-to-circular adapter. This adapter can be mounted onto the existing square junction box, and the surrounding area can be covered with drywall, ensuring that the new thermostat has a cosmetically appealing circular mounting base. This approach not only saves time and effort but also avoids the higher costs associated with replacing the entire junction box.

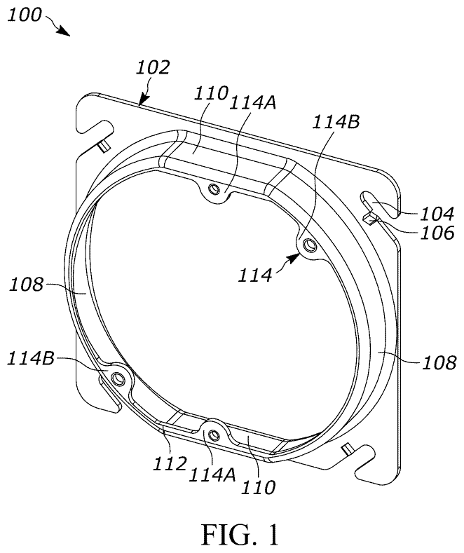

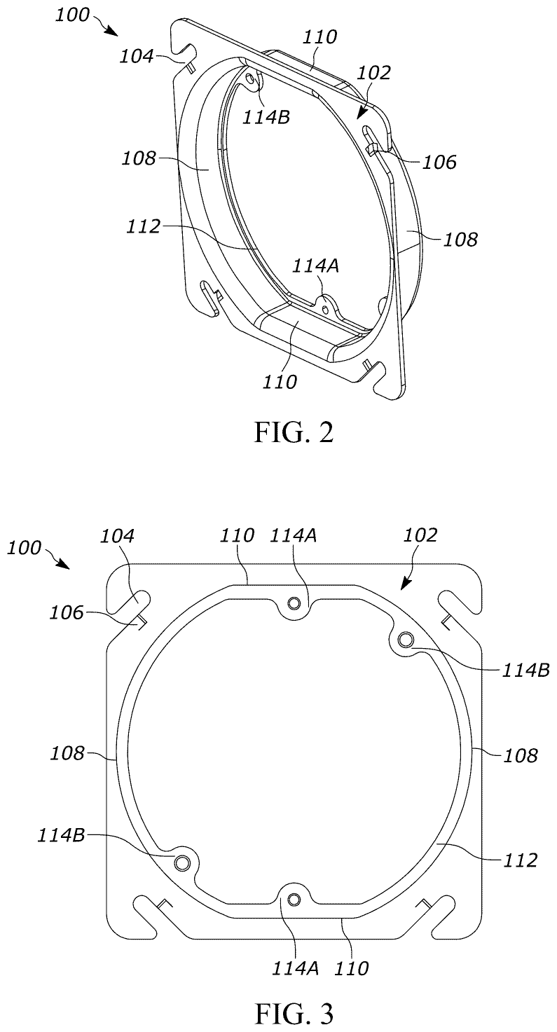

FIGS. 1-3 show an exemplary configuration of a cover 100 having a base 102. The base 102 has a substantially planar front and rear surface. The base 102 has a substantially square outer configuration with four rectilinear sides connected by rounded corners. The base 102 can be formed in other shapes, such as rectangular or round to accommodate the shape of a corresponding electrical box as needed.

One or more slots 104 can be provided in the base 102. The slots 104 are configured to receive a fastener to secure the base 102 to an electrical box. The slots 104 can be positioned in one or more corners of the base 102. Although four slots 104 are shown, other configurations can utilize fewer slots, such as two opposing slots, or more slots to provide different mounting positions for the base 102. The slots 104 extend inwardly from the side edges of the base 102 at an oblique angle. Different angles can be used for each individual slot 104, including having slots 104 that extend substantially perpendicular to the side edges.

Tabs 106 can extend from the base 102 adjacent the slots 104. The tabs 106 can be positioned to engage a fastener securing the base 102 to the electrical box. The frictional engagement of the fastener with the base 102 will typically hold the cover 100 in place. If the fastener loosens, the tabs 106 can help prevent the base 102 from being dislodged by engaging the fastener if the base 102 begins to slide or rotate out of place.

One or more side walls extend from the base 102 around a central opening. In certain configurations, the side walls include one or more curvilinear side walls 108 and one or more rectilinear side walls 110. The number, type, and size of the curvilinear side walls 108 and the rectilinear side walls 110 can vary depending on the desired configuration and use of electrical box and electrical device. The height of the side walls 108, 110 can also be adjusted to accommodate different mounting depths for an electrical box relative to a finished surface, such as a ceiling or wall.

The illustrated configuration shows a pair of opposing curvilinear side walls 108 and a pair of opposing rectilinear side walls 110. The curvilinear side walls 108 are arcuate with a common radius, although different concave and convex curved shapes can be used as needed.

In certain configurations, an outer edge 112 extends from the side walls 108, 110. The outer edge 112 can extend into the central opening. The illustrated configuration shows the outer edge 112 extending continuously from the side walls 108, 110. In other configurations, the outer edge 112 can be non-continuous and can extend from at least a portion of the curvilinear side walls 108, the rectilinear side walls 110, or a combination of both.

In certain configurations, one or more ears 114 extend from the outer edge 112. The ears 114 include an opening for receiving a fastener to secure an electrical device to the cover 100. The openings can be threaded or grooved to help retain a fastener. The number of ears 114 and their placement can be varied to provide different mounting options for different devices.

In the illustrated configuration a first set of ears 114A extend from the rectilinear side walls 110 and a second set of ears 114B extend from the curvilinear side walls 108. The first set of ears 114A is positioned substantially along a vertical axis of the cover. The second set of ears 114B can be offset from the first set of ears 114A at an oblique angle, for example by approximately 45 degrees. Other positions can also be used.

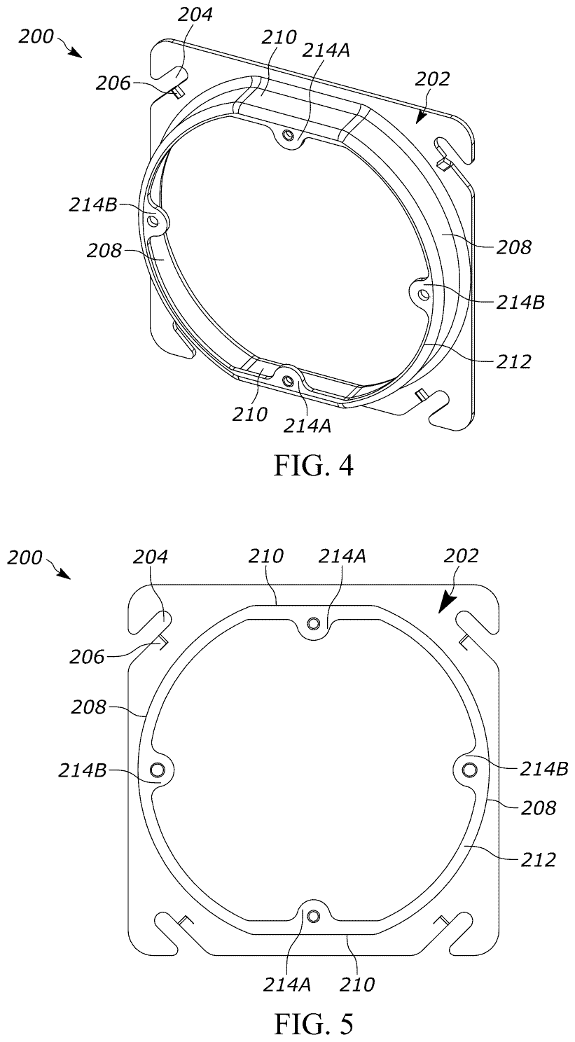

FIGS. 4-5 show an exemplary configuration of a cover 200 having a base 202. The base 202 has a substantially planar front and rear surface. The base 202 has a substantially square outer configuration with four rectilinear sides connected by rounded corners. The base 202 can be formed in other shapes, such as rectangular or round to accommodate the shape of a corresponding electrical box as needed.

One or more slots 204 can be provided in the base 202. The slots 204 are configured to receive a fastener to secure the base 202 to an electrical box. The slots 204 can be positioned in one or more corners of the base 202. Although four slots 204 are shown, other configurations can utilize fewer slots, such as two opposing slots, or more slots to provide different mounting positions for the base 202. The slots 204 extend inwardly from the side edges of the base 202 at an oblique angle. Different angles can be used for each individual slot 204, including having slots 204 that extend substantially perpendicular to the side edges.

Tabs 206 can extend from the base 202 adjacent the slots 204. The tabs 206 can be positioned to engage a fastener securing the base 202 to the electrical box. The frictional engagement of the fastener with the base 202 will typically hold the cover 200 in place. If the fastener loosens, the tabs 206 can help prevent the base 202 from being dislodged by engaging the fastener if the base 202 begins to slide or rotate out of place.

One or more side walls extend from the base 202 around a central opening. In certain configurations, the side walls include one or more curvilinear side walls 208 and one or more rectilinear side walls 210. The number, type, and size of the curvilinear side walls 208 and the rectilinear side walls 210 can vary depending on the desired configuration and use of electrical box and electrical device. The height of the side walls 208, 210 can also be adjusted to accommodate different mounting depths for an electrical box relative to a finished surface, such as a ceiling or wall.

The illustrated configuration shows a pair of opposing curvilinear side walls 208 and a pair of opposing rectilinear side walls 210. The curvilinear side walls 208 are arcuate with a common radius, although different concave and convex curved shapes can be used as needed.

In certain configurations, an outer edge 212 extends from the side walls 208, 210. The outer edge 212 can extend into the central opening. The illustrated configuration shows the outer edge 212 extending continuously from the side walls 208, 210. In other configurations, the outer edge 212 can be non-continuous and can extend from at least a portion of the curvilinear side walls 208, the rectilinear side walls 210, or a combination of both.

In certain configurations, one or more ears extend from the outer edge 212. The ears include an opening for receiving a fastener to secure an electrical device to the cover 200. The openings can be threaded or grooved to help retain a fastener. The number of ears and their placement can be varied to provide different mounting options for different devices.

In the illustrated configuration a first set of ears 214A extend from the rectilinear side walls 210 and a second set of ears 214B extend from the curvilinear side walls 208. The first set of ears 214A is positioned substantially along a vertical axis of the cover. The second set of ears 214B is positioned substantially along a horizontal axis of the cover, offset from the first set of ears 214A by approximately 90 degrees. Other positions can also be used.

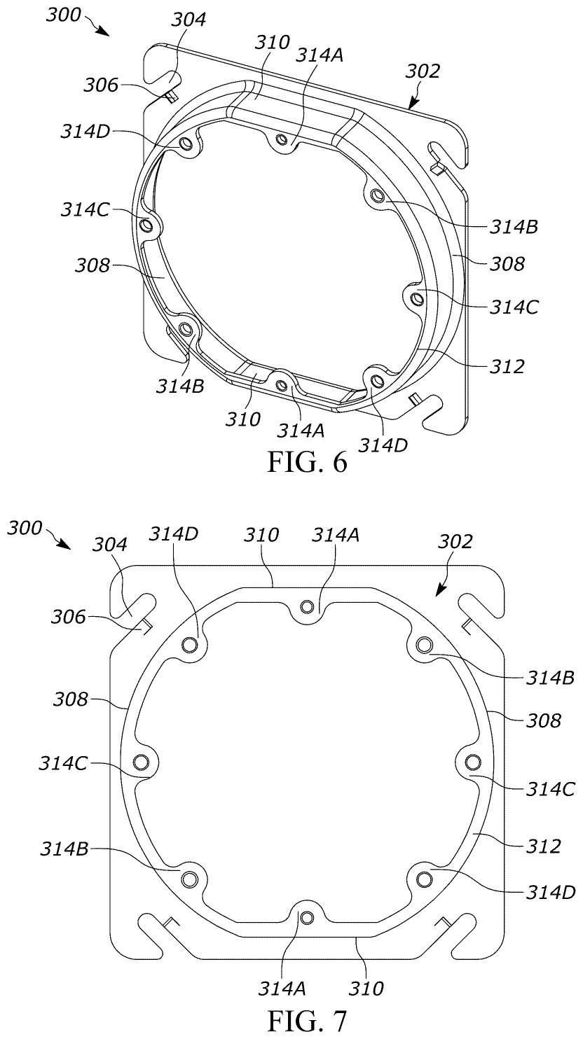

FIGS. 6-7 show an exemplary configuration of a cover 300 having a base 302. The base 302 has a substantially planar front and rear surface. The base 302 has a substantially square outer configuration with four rectilinear sides connected by rounded corners. The base 302 can be formed in other shapes, such as rectangular or round to accommodate the shape of a corresponding electrical box as needed.

One or more slots 304 can be provided in the base 302. The slots 304 are configured to receive a fastener to secure the base 302 to an electrical box. The slots 304 can be positioned in one or more corners of the base 302. Although four slots 304 are shown, other configurations can utilize fewer slots, such as two opposing slots, or more slots to provide different mounting positions for the base 302. The slots 304 extend inwardly from the side edges of the base 302 at an oblique angle. Different angles can be used for each individual slot 304, including having slots 304 that extend substantially perpendicular to the side edges.

Tabs 306 can extend from the base 302 adjacent the slots 304. The tabs 306 can be positioned to engage a fastener securing the base 302 to the electrical box. The frictional engagement of the fastener with the base 302 will typically hold the cover 300 in place. If the fastener loosens, the tabs 306 can help prevent the base 302 from being dislodged by engaging the fastener if the base 302 begins to slide or rotate out of place.

One or more side walls extend from the base 302 around a central opening. In certain configurations, the side walls include one or more curvilinear side walls 308 and one or more rectilinear side walls 310. The number, type, and size of the curvilinear side walls 308 and the rectilinear side walls 310 can vary depending on the desired configuration and use of electrical box and electrical device. The height of the side walls 308, 310 can also be adjusted to accommodate different mounting depths for an electrical box relative to a finished surface, such as a ceiling or wall.

The illustrated configuration shows a pair of opposing curvilinear side walls 308 and a pair of opposing rectilinear side walls 310. The curvilinear side walls 308 are arcuate with a common radius, although different concave and convex curved shapes can be used as needed.

In certain configurations, an outer edge 312 extends from the side walls 308, 310. The outer edge 312 can extend into the central opening. The illustrated configuration shows the outer edge 312 extending continuously from the side walls 308, 310. In other configurations, the outer edge 312 can be non-continuous and can extend from at least a portion of the curvilinear side walls 308, the rectilinear side walls 310, or a combination of both.

In certain configurations, one or more ears extend from the outer edge 312. The ears include an opening for receiving a fastener to secure an electrical device to the cover 300. The openings can be threaded or grooved to help retain a fastener. The number of ears and their placement can be varied to provide different mounting options for different devices.

In the illustrated configuration a first set of ears 314A extend from the rectilinear side walls 310, positioned substantially along a vertical axis of the cover 300. A second set of ears 314B extend from the curvilinear side wall 308 offset from the first set of ears 314A at approximately 45 degrees. A third set of ears 314C extends from the curvilinear side wall 308 along a substantially horizontal axis of the cover 300. A fourth set of ears 314D extend from the curvilinear side wall 308 offset from the third set of ears 314C at approximately 45 degrees. Other positions can also be used.

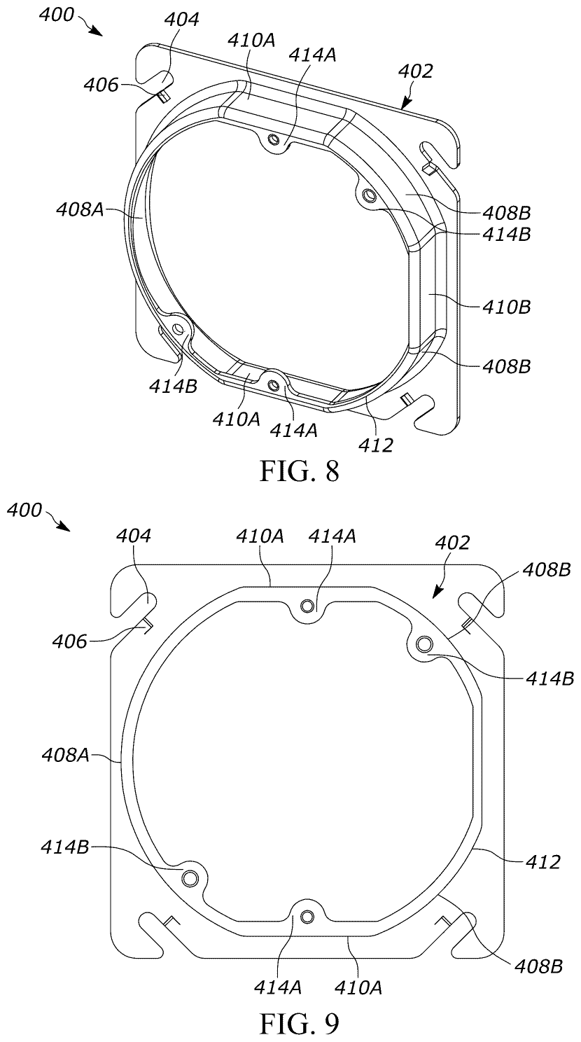

FIGS. 8-9 show an exemplary configuration of a cover 400 having a base 402. The base 402 has a substantially planar front and rear surface. The base 402 has a substantially square outer configuration with four rectilinear sides connected by rounded corners. The base 402 can be formed in other shapes, such as rectangular or round to accommodate the shape of a corresponding electrical box as needed.

One or more slots 404 can be provided in the base 402. The slots 404 are configured to receive a fastener to secure the base 402 to an electrical box. The slots 404 can be positioned in one or more corners of the base 402. Although four slots 404 are shown, other configurations can utilize fewer slots, such as two opposing slots, or more slots to provide different mounting positions for the base 402. The slots 404 extend inwardly from the side edges of the base 402 at an oblique angle. Different angles can be used for each individual slot 404, including having slots 404 that extend substantially perpendicular to the side edges.

Tabs 406 can extend from the base 402 adjacent the slots 404. The tabs 406 can be positioned to engage a fastener securing the base 402 to the electrical box. The frictional engagement of the fastener with the base 402 will typically hold the cover 400 in place. If the fastener loosens, the tabs 406 can help prevent the base 402 from being dislodged by engaging the fastener if the base 402 begins to slide or rotate out of place.

One or more side walls extend from the base 402 around a central opening. In certain configurations, the side walls include one or more curvilinear side walls and one or more rectilinear side walls. The number, type, and size of the curvilinear side walls and the rectilinear side walls can vary depending on the desired configuration and use of electrical box and electrical device. The height of the side walls can also be adjusted to accommodate different mounting depths for an electrical box relative to a finished surface, such as a ceiling or wall.

The illustrated configuration shows a first major curvilinear side wall 408A and a pair of minor curvilinear side walls 408B. A first pair of opposing major rectilinear side walls 410A are positioned on the top and bottom of the cover and a minor rectilinear side wall 410B is positioned between the minor curvilinear side walls 408B. The curvilinear side walls 408A, 408B are arcuate with a common radius, although different concave and convex curved shapes can be used as needed.

In certain configurations, an outer edge 412 extends from the side walls 408A, 408B, 410A, 410B. The outer edge 412 can extend into the central opening. The illustrated configuration shows the outer edge 412 extending continuously from the side walls 408A, 408B, 410A, 410B. In other configurations, the outer edge 212 can be non-continuous and can extend from at least a portion of the curvilinear side walls 408A, 408B, the rectilinear side walls 410A, 410B, or a combination of both.

In certain configurations, one or more ears extend from the outer edge 412. The ears include an opening for receiving a fastener to secure an electrical device to the cover 400. The openings can be threaded or grooved to help retain a fastener. The number of ears and their placement can be varied to provide different mounting options for different devices.

In the illustrated configuration a first set of ears 414A extend from the major rectilinear side walls 410A and a second set of ears 414B extend from the major curvilinear side wall 408A and an opposing portion of the minor curvilinear side wall 408B. The first set of ears 414A is positioned substantially along a vertical axis of the cover. The second set of ears 414B can be offset from the first set of ears 414A at an oblique angle, for example by approximately 45 degrees. Other positions can also be used.

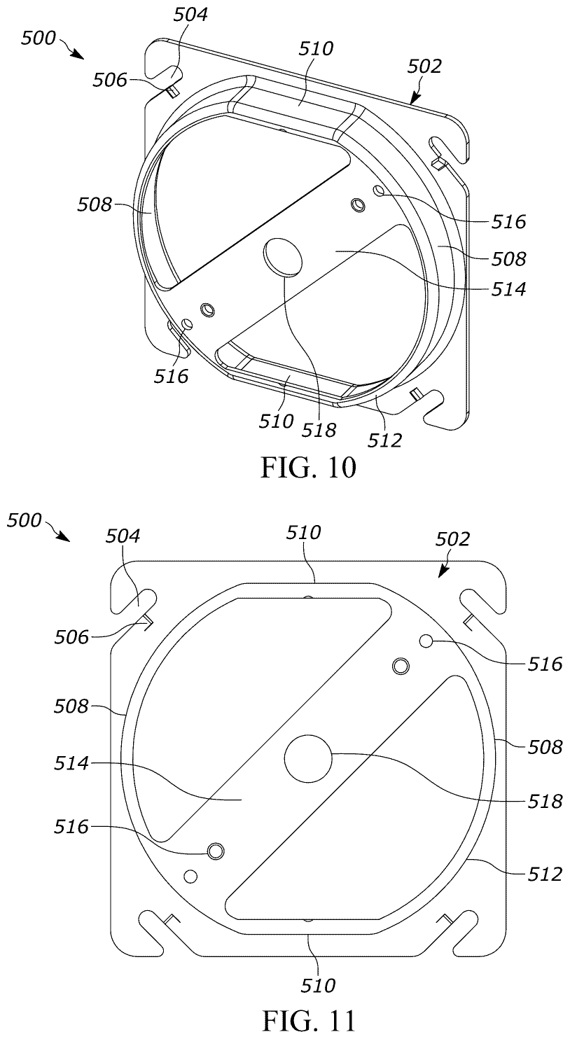

FIGS. 10-11 show an exemplary configuration of a cover 500 having a base 502. The base 502 has a substantially planar front and rear surface. The base 502 has a substantially square outer configuration with four rectilinear sides connected by rounded corners. The base 502 can be formed in other shapes, such as rectangular or round to accommodate the shape of a corresponding electrical box as needed.

One or more slots 504 can be provided in the base 502. The slots 504 are configured to receive a fastener to secure the base 502 to an electrical box. The slots 504 can be positioned in one or more corners of the base 502. Although four slots 504 are shown, other configurations can utilize fewer slots, such as two opposing slots, or more slots to provide different mounting positions for the base 502. The slots 504 extend inwardly from the side edges of the base 502 at an oblique angle. Different angles can be used for each individual slot 504, including having slots 504 that extend substantially perpendicular to the side edges.

Tabs 506 can extend from the base 502 adjacent the slots 504. The tabs 506 can be positioned to engage a fastener securing the base 502 to the electrical box. The frictional engagement of the fastener with the base 502 will typically hold the cover 500 in place. If the fastener loosens, the tabs 506 can help prevent the base 502 from being dislodged by engaging the fastener if the base 502 begins to slide or rotate out of place.

One or more side walls extend from the base 502 around a central opening. In certain configurations, the side walls include one or more curvilinear side walls 508 and one or more rectilinear side walls 510. The number, type, and size of the curvilinear side walls 508 and the rectilinear side walls 510 can vary depending on the desired configuration and use of electrical box and electrical device. The height of the side walls 508, 510 can also be adjusted to accommodate different mounting depths for an electrical box relative to a finished surface, such as a ceiling or wall.

The illustrated configuration shows a pair of opposing curvilinear side walls 508 and a pair of opposing rectilinear side walls 510. The curvilinear side walls 508 are arcuate with a common radius, although different concave and convex curved shapes can be used as needed.

In certain configurations, an outer edge 512 extends from the side walls 508, 510. The outer edge 512 can extend into the central opening. The illustrated configuration shows the outer edge 512 extending continuously from the side walls 508, 510. In other configurations, the outer edge 512 can be non-continuous and can extend from at least a portion of the curvilinear side walls 508, the rectilinear side walls 510, or a combination of both.

In certain configurations, a cross brace 514 extends across the central opening. The cross brace 514 can be substantially centrally positioned to extend from one portion of the side walls 508, 510 to an opposing portion of the side walls 508, 510. In the illustrated configuration, a first end of the cross brace 514 extends from a portion of a first curvilinear side wall 508 to an opposing portion of a second curvilinear side wall 508.

The cross brace 514 can include one or more openings to connect external components to the cover 500. In the illustrated configuration, the cross brace 514 includes a set of outer openings 516 and a central opening 518. The outer openings 516 can be threaded or non-threaded. The illustrated central opening 518 is shown as non-threaded although a threaded opening may also be used. The outer openings 516 and central opening 518 can be used to connect various electrical devices. The size, position, and type of openings can be varied as needed to accommodate different electrical devices.

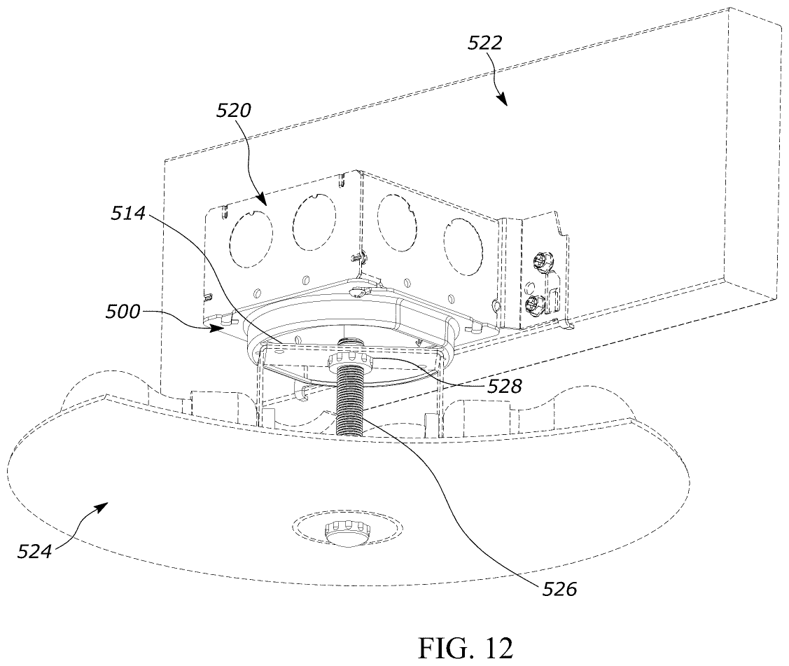

FIG. 12 shows an exemplary implementation of the cover 500 connected to an electrical box 520. The electrical box 520 is connected to a support 522, for example a ceiling header. A light fixture 524 is connected to the cover 500 using the central opening 518. A threaded post 526 is placed through the central opening 518 and one or more nuts 528 can be connected to the threaded post 526 to secure the threaded post 526 relative to the cross brace 514. The light fixture 524 is then connected to the threaded post 526.

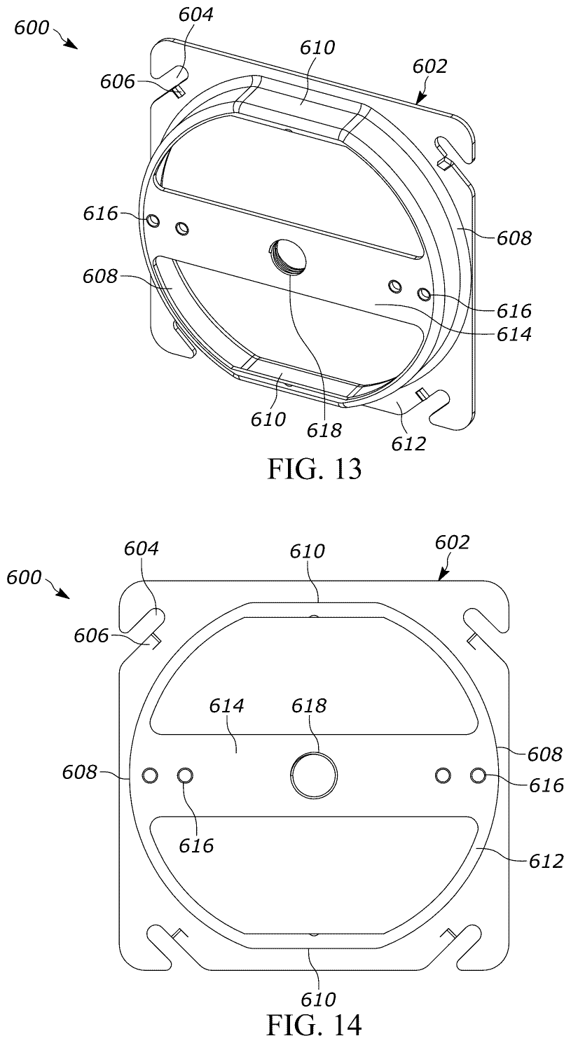

FIGS. 13-14 show an exemplary configuration of a cover 600 having a base 602. The base 602 has a substantially planar front and rear surface. The base 602 has a substantially square outer configuration with four rectilinear sides connected by rounded corners. The base 602 can be formed in other shapes, such as rectangular or round to accommodate the shape of a corresponding electrical box as needed.

One or more slots 604 can be provided in the base 602. The slots 604 are configured to receive a fastener to secure the base 602 to an electrical box. The slots 604 can be positioned in one or more corners of the base 602. Although four slots 604 are shown, other configurations can utilize fewer slots, such as two opposing slots, or more slots to provide different mounting positions for the base 602. The slots 604 extend inwardly from the side edges of the base 602 at an oblique angle. Different angles can be used for each individual slot 604, including having slots 604 that extend substantially perpendicular to the side edges.

Tabs 606 can extend from the base 602 adjacent the slots 604. The tabs 606 can be positioned to engage a fastener securing the base 602 to the electrical box. The frictional engagement of the fastener with the base 602 will typically hold the cover 600 in place. If the fastener loosens, the tabs 606 can help prevent the base 602 from being dislodged by engaging the fastener if the base 602 begins to slide or rotate out of place.

One or more side walls extend from the base 602 around an interior. In certain configurations, the side walls include one or more curvilinear side walls 608 and one or more rectilinear side walls 610. The number, type, and size of the curvilinear side walls 608 and the rectilinear side walls 610 can vary depending on the desired configuration and use of electrical box and electrical device. The height of the side walls 608, 610 can also be adjusted to accommodate different mounting depths for an electrical box relative to a finished surface, such as a ceiling or wall.

The illustrated configuration shows a pair of opposing curvilinear side walls 608 and a pair of opposing rectilinear side walls 610. The curvilinear side walls 608 are arcuate with a common radius, although different concave and convex curved shapes can be used as needed.

In certain configurations, an outer edge 612 extends from the side walls 608, 610. The outer edge 612 can extend into the interior. The illustrated configuration shows the outer edge 612 extending continuously from the side walls 608, 610. In other configurations, the outer edge 612 can be non-continuous and can extend from at least a portion of the curvilinear side walls 608, the rectilinear side walls 610, or a combination of both.

In certain configurations, a cross brace 614 extends across the interior. The cross brace 614 can be substantially centrally positioned to extend from one portion of the side walls 608, 610 to an opposing portion of the side walls 608, 610. In the illustrated configuration, the cross brace 614 extends substantially along a horizontal axis of the cover 600 from a portion of a first curvilinear side wall 608 to an opposing portion of a second curvilinear side wall 608.

The cross brace 614 can include one or more openings to connect external components to the cover 600. In the illustrated configuration, the cross brace 614 includes a set of outer openings 616 and a central opening 618. The outer openings 616 can be threaded or non-threaded. The illustrated central opening 618 is shown as non-threaded although a threaded opening may also be used. The outer openings 616 and central opening 618 can be used to connect various electrical devices. The size, position, and type of openings can be varied as needed to accommodate different electrical devices.

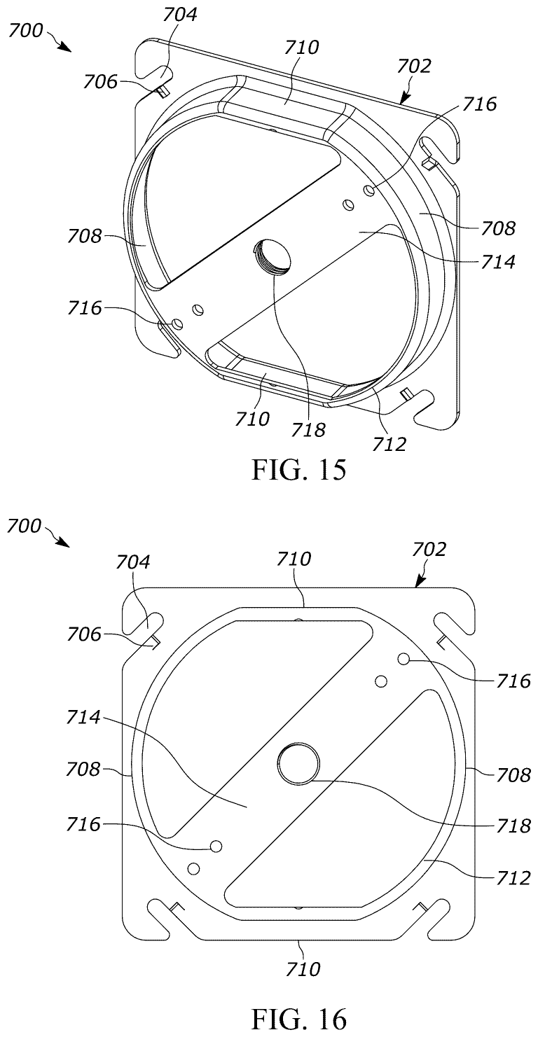

FIGS. 15-16 show an exemplary configuration of a cover 700 having a base 702. The base 702 has a substantially planar front and rear surface. The base 702 has a substantially square outer configuration with four rectilinear sides connected by rounded corners. The base 702 can be formed in other shapes, such as rectangular or round to accommodate the shape of a corresponding electrical box as needed.

One or more slots 704 can be provided in the base 702. The slots 704 are configured to receive a fastener to secure the base 702 to an electrical box. The slots 704 can be positioned in one or more corners of the base 702. Although four slots 704 are shown, other configurations can utilize fewer slots, such as two opposing slots, or more slots to provide different mounting positions for the base 702. The slots 704 extend inwardly from the side edges of the base 702 at an oblique angle. Different angles can be used for each individual slot 704, including having slots 704 that extend substantially perpendicular to the side edges.

Tabs 706 can extend from the base 702 adjacent the slots 704. The tabs 706 can be positioned to engage a fastener securing the base 702 to the electrical box. The frictional engagement of the fastener with the base 702 will typically hold the cover 700 in place. If the fastener loosens, the tabs 706 can help prevent the base 702 from being dislodged by engaging the fastener if the base 702 begins to slide or rotate out of place.

One or more side walls extend from the base 702 around an interior. In certain configurations, the side walls include one or more curvilinear side walls 708 and one or more rectilinear side walls 710. The number, type, and size of the curvilinear side walls 708 and the rectilinear side walls 710 can vary depending on the desired configuration and use of electrical box and electrical device. The height of the side walls 708, 710 can also be adjusted to accommodate different mounting depths for an electrical box relative to a finished surface, such as a ceiling or wall.

The illustrated configuration shows a pair of opposing curvilinear side walls 708 and a pair of opposing rectilinear side walls 710. The curvilinear side walls 708 are arcuate with a common radius, although different concave and convex curved shapes can be used as needed.

In certain configurations, an outer edge 712 extends from the side walls 708, 710. The outer edge 712 can extend into the interior. The illustrated configuration shows the outer edge 712 extending continuously from the side walls 708, 710. In other configurations, the outer edge 712 can be non-continuous and can extend from at least a portion of the curvilinear side walls 708, the rectilinear side walls 710, or a combination of both.

In certain configurations, a cross brace 714 extends across the interior. The cross brace 714 can be substantially centrally positioned to extend from one portion of the side walls 708, 710 to an opposing portion of the side walls 708, 710. In the illustrated configuration, a first end of the cross brace 714 extends from a portion of a first curvilinear side wall 708 to an opposing portion of a second curvilinear side wall 708.

The cross brace 714 can include one or more openings to connect external components to the cover 700. In the illustrated configuration, the cross brace 714 includes a set of outer openings 716 and a central opening 718. The outer openings 716 can be threaded or non-threaded. The illustrated central opening 718 is shown as threaded. The outer openings 716 and central opening 718 can be used to connect various electrical devices. The size, position, and type of openings can be varied as needed to accommodate different electrical devices.

The components of the covers can be integrally formed or various components can be formed separately and connected together, for example through fasteners or a joining process such as welding. In certain configurations, the covers can be integrally formed using a stamping processes such as a progressive die stamping process.

Certain installations can require an electrical box to be positioned inside of a support, such as a hollow core masonry building block or an opening in a concrete wall. In these masonry installations, the electrical box needs to be positioned during installation in a manner that does not interfere with the construction of the wall or damage the structural integrity of the wall. Certain installations can therefore require the electrical box to be positioned in the block without the use of fasteners until completion of the wall. After the wall is complete, the box can be mortared in place.

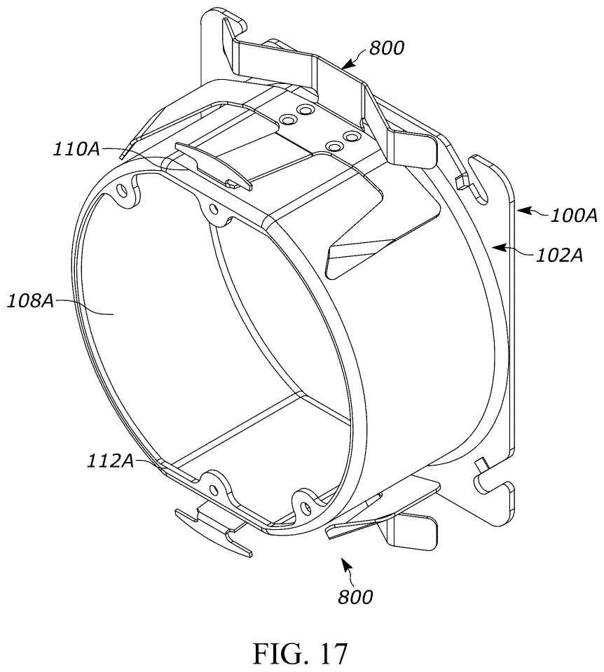

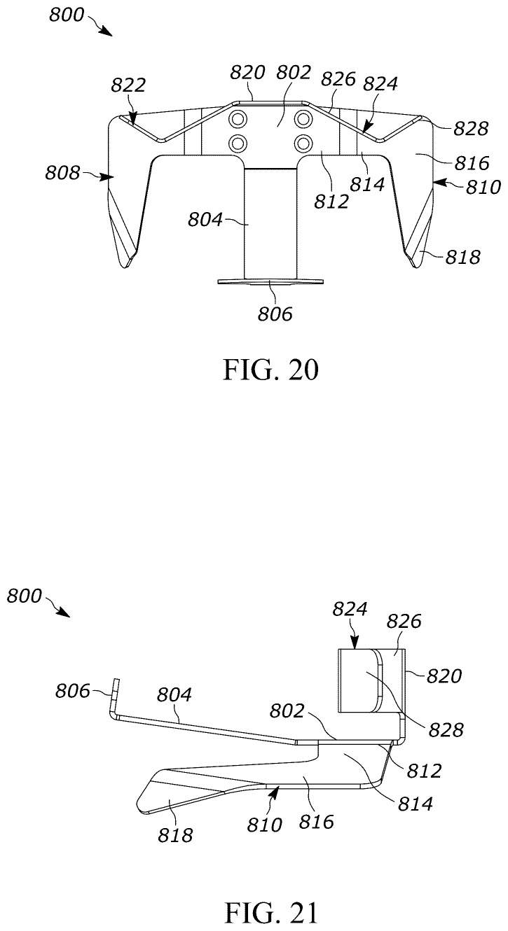

FIGS. 17-21 show a bracket 800 that can be connected to a cover 100A to position the cover 100A and a connected electrical box in a masonry installation. The cover 100A includes a base 102A and a plurality of side walls 108A, 110A. One or more brackets 800 can retain the cover 100A and electrical box in an opening in a masonry wall, such as a block or brick wall. The brackets 800 can be configured to position the cover vertically, horizontally, and at a required depth. The size, shape, and position of the brackets 800 can be adjusted as needed to work with different material and sizes of supports.

As best shown in FIG. 17, a pair of brackets 800 can be used, with one positioned on each of the rectilinear sides 108A of the cover 100A. The brackets 800 can be connected to the cover 100A using one or more fasteners, such as rivets, bolts, or screws. Other connections, such as a joining process can also be used. The location of the brackets 800 relative to the cover 100A can be adjusted to provide a required depth for the electrical box or an associated electrical device. A bracket 800 can be secured to each of the rectilinear walls 110A as shown. Other attachment configurations can also be used.

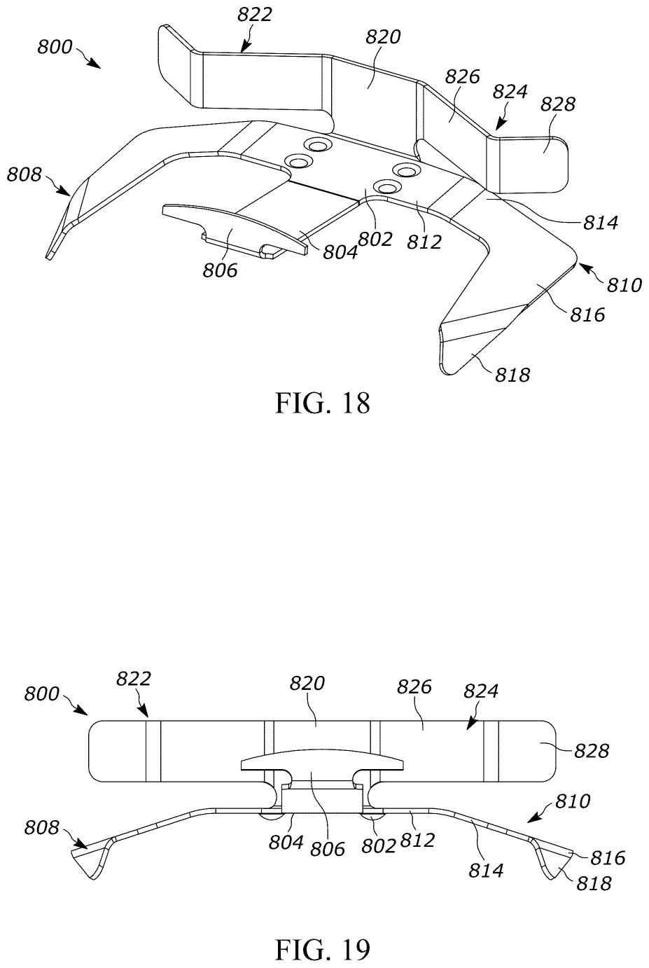

FIGS. 18-21 show an exemplary configuration of the bracket 800. The bracket 800 has a body 802 that can be secured to the cover 100A. The body 802 can include one or more openings for receiving a fastener to secure the bracket 800 to the cover 100A. The openings can receive rivets, bolts, threaded fasteners, or other types of fasteners. The bracket 800 can also be connected through a joining process such as welding, soldering, or adhesives, and the openings can be used to receive a joining material.

A leg 804 extends from the body 802 toward the outer edge 112A of the cover 100A. The leg 804 can extend from the body 802 at an oblique angle away from the rectilinear wall 110A. The leg 804 can therefore be spaced form the rectilinear wall 110A by a separation distance that increases from the body 802 toward a distal end of the leg 804. In certain configurations, the leg 804 can be resilient relative to the body 802 and can be capable of providing a spring force. The leg 804 can help position the cover 100A relative to an opening in a support, for example in a vertical direction for an opening in a wall.

A flange 806 extends from the leg 804. The flange 806 can be connected to the distal end of the leg 804 and extend from the leg 804 in a direction away from the center of the cover 100A. In certain configurations, the flange 806 can extend substantially perpendicular relative to a plane of the body 802 in a direction opposite the center of the cover 100A. The flange 806 can be used to position the bracket 800 relative to an outer surface of a support structure. For example, the flange 806 can engage the outer surface of a wall. In certain configurations, the flange 806 can be wider than the leg 804 and can have a curved upper edge and tapered ends. The size of the flange 806 can be sufficient to contact the outer surface of a support to stabilize the cover 100A and an associated electrical box during installation. In certain implementations, the flange 806 can be bent by a user from an initial horizontal position to the final vertical position show. In this way, the leg 804 and the flange 806 can be initially positioned through an opening during installation and then subsequently bent to provide stabilization and resist pull out back through the opening.

One or more lower spring members extend from either side of the body. The lower spring members can be used to position the cover and electrical box in an opening, for example in a horizontal and vertical direction. The lower spring members can include a resilient portion. The lower spring members can be configured to engage the interior of an opening and provide a spring force to help center the cover 100A relative to the opening.

In certain configurations the lower spring members include a first wing 808 and a second wing 810. Each of the wings 808, 810 includes a first portion 812 extending from the body 802. A second portion 814 can extend from the first portion at a downward angle toward the center of the cover 100A. A third portion 816 can extend from the second portion 814. The third portion 816 can include a forwardly extending arm that extends toward the outer edge 112A of the cover 100A. The arm can taper to a distal tip 818 and include one or more angled sections and a rounded end.

One or more upper spring members extend from the body. The upper spring members can be used to position the cover 100A and electrical box relative to a support surface, for example in a depth direction of an opening in a support surface. The upper spring member can include one or more resilient portions. The upper spring members can be configured to engage the exterior surface of a support adjacent an opening and provide a spring force to help position the cover 100A at an appropriate depth relative to the opening.

In certain configurations, the upper spring member can include a central portion 820 extending substantially perpendicular to the body. A first arm 822 and a second arm 824 can extend from the central portion 820. Each of the first and second arms 822, 824 can include a first portion 826 that extends at an angle relative to the central portion 820. The first portion 826 can extend toward the outer edge 112A of the cover 100A. A second portion 828 extends at an angle relative to the first portion 826. The second portion 828 can extend away from the outer edge 112A of the cover 100A. A curved transition can be provided between the first portion 826 and the second portion 828.

In certain configurations the bracket 800 is made from sheet steel that is cut and folded to form the components. Preferably, the steel has sufficient strength and resilience to secure the cover 100A in the opening of a support, such as a block wall. Alternatively, the bracket 800 can be made of other material such as a molded one-piece plastic material.

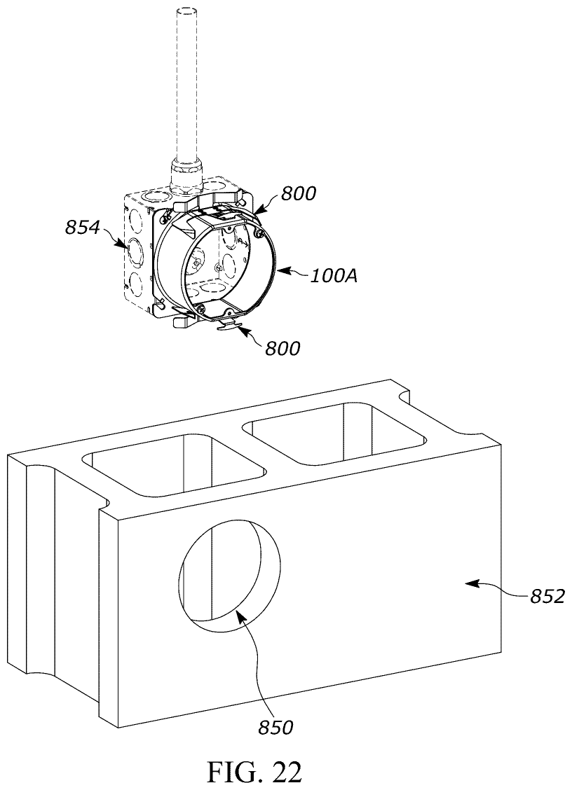

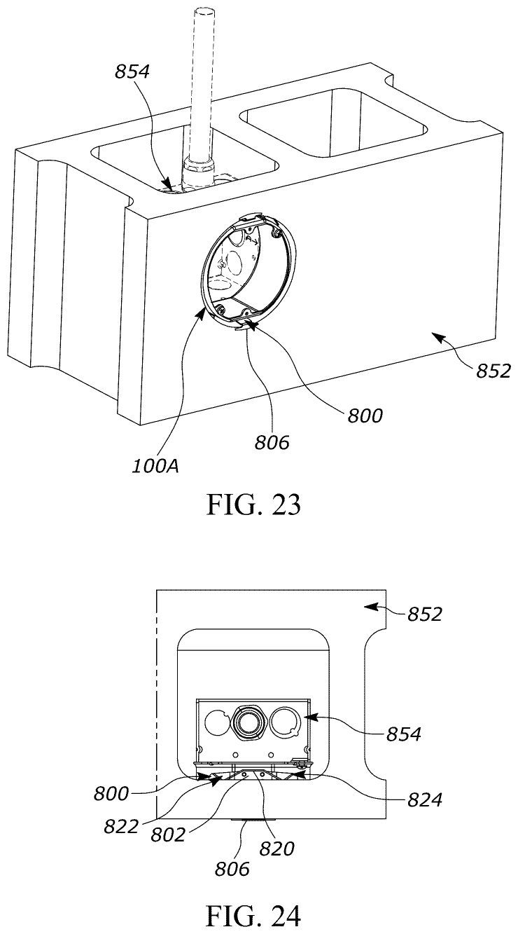

In an exemplary implementation, and opening 850 can be formed in a support, such as a wall 852 as shown in FIG. 22. The brackets 800 can be connected to a cover 100A and the cover 100A connected to an electrical box 854. The cover 100A and electrical box 854 can be slid into the opening 850 in the wall 852 and the flange 806 can be bent upwards so that it will engage the outer surface of the support as shown in FIGS. 23 and 24. The lower spring members can engage the interior of the opening 850 and the upper spring member can engage the interior surface of the wall 852. The bracket 800 accordingly supports the cover 100A and the electrical box 854 in a fixed position to prevent separation and movement of the electrical box 854 with respect to the support. The cover 100A and electrical box 854 can be subsequently secured to the support with material, such as mortar and an electrical device, such as a switch or light fixture, can be connected to the cover 100A.

Although shown used with the cover 100A, the bracket 800 can be used with different electrical boxes and electrical box attachment components such as any of the exemplary covers described herein.

In certain installations, an electrical box can be installed in a building prior to the installation of sheet rock, wall board, or other surface material. Typically, an extension member, known as a mud ring, plaster ring, extension ring, or other term are attached to the box prior to the installation of the surface material. To avoid the need to select a mud ring of a specific depth or have the electrical box at an exact position, adjustable mud rings can be used. An adjustable mud ring allows the front edge to be extended or retracted to meet the necessary codes, to provide a guide during the wall covering trimming process, to prevent the box from being filled with drywall spackling paste (also known as mud), and other advantages.

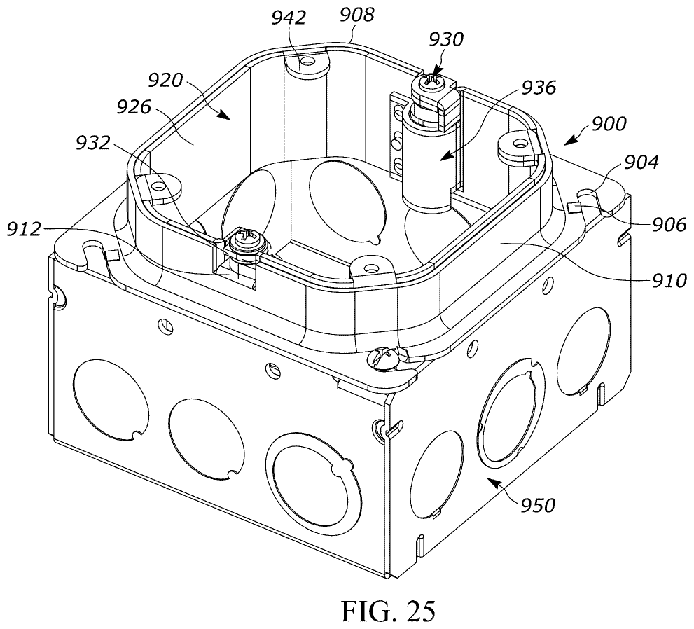

FIG. 25 shows an exemplary embodiment of a cover 900 and an adjustable ring 920 that can be connected to an electrical box 950. The adjustable ring 920 can move relative to the cover 900 and the electrical box 950 so that an outer edge of the assembly can be adjusted for a desired depth. In the illustrated exemplary configuration, one or more drive members can be rotated to cause translation of the ring 920 relative to the cover 900.

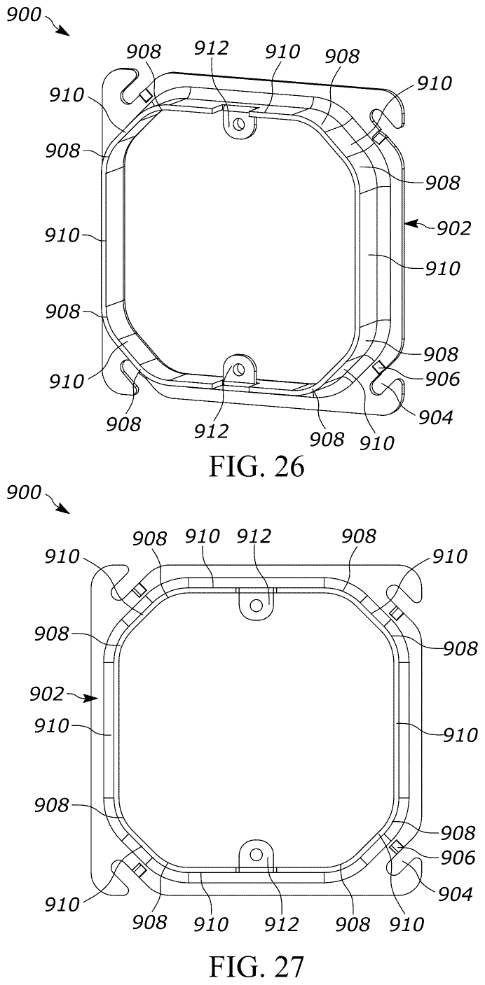

FIGS. 26 and 27 show an exemplary configuration of the cover 900 having a base 902. The base 902 has a substantially planar front and rear surface. The base 902 has a substantially square outer configuration with four rectilinear sides connected by rounded corners. The base 902 can be formed in other shapes, such as rectangular or round to accommodate the shape of a corresponding electrical box as needed.

One or more slots 904 can be provided in the base 902. The slots 904 are configured to receive a fastener to secure the base 902 to an electrical box. The slots 904 can be positioned in one or more corners of the base 902. Although four slots 904 are shown, other configurations can utilize fewer slots, such as two opposing slots, or more slots to provide different mounting positions for the base 902. The slots 904 extend inwardly from the side edges of the base 902 at an oblique angle. Different angles can be used for each individual slot 904, including having slots 904 that extend substantially perpendicular to the side edges.

Tabs 906 can extend from the base 902 adjacent the slots 904. The tabs 906 can be positioned to engage a fastener securing the base 902 to the electrical box. The frictional engagement of the fastener with the base 902 will typically hold the cover 900 in place. If the fastener loosens, the tabs 906 can help prevent the base 902 from being dislodged by engaging the fastener if the base 902 begins to slide or rotate out of place.

One or more side walls extend from the base 902 around an interior. In certain configurations, the side walls include one or more curvilinear side walls 908 and one or more rectilinear side walls 910. The number, type, and size of the curvilinear side walls 908 and the rectilinear side walls 910 can vary depending on the desired configuration and use of electrical box and electrical device. The height of the side walls 908, 910 can also be adjusted to accommodate different mounting depths for an electrical box relative to a finished surface, such as a ceiling or wall.

The illustrated configuration shows four pairs of opposing rectilinear side walls 910 and a curvilinear side wall 908 extending between each of the rectilinear side walls 910. The curvilinear side walls 908 are arcuate with a common radius, although different concave and convex curved shapes can be used as needed.

In certain configurations, one or more flanges 912 extends from one or more of the side walls 908, 910. The flanges 912 include an opening for receiving a fastener to adjustably secure the ring 920 to the cover 900. The openings can be threaded or grooved to help retain a fastener. The number of flanges and their placement can be varied to provide different mounting options for different devices.

In the illustrated configuration a first set of flanges 912 extend from opposing the rectilinear side walls 910. The flanges 912 can be recessed from an outer edge of the side walls 908, 910. Other positions can also be used.

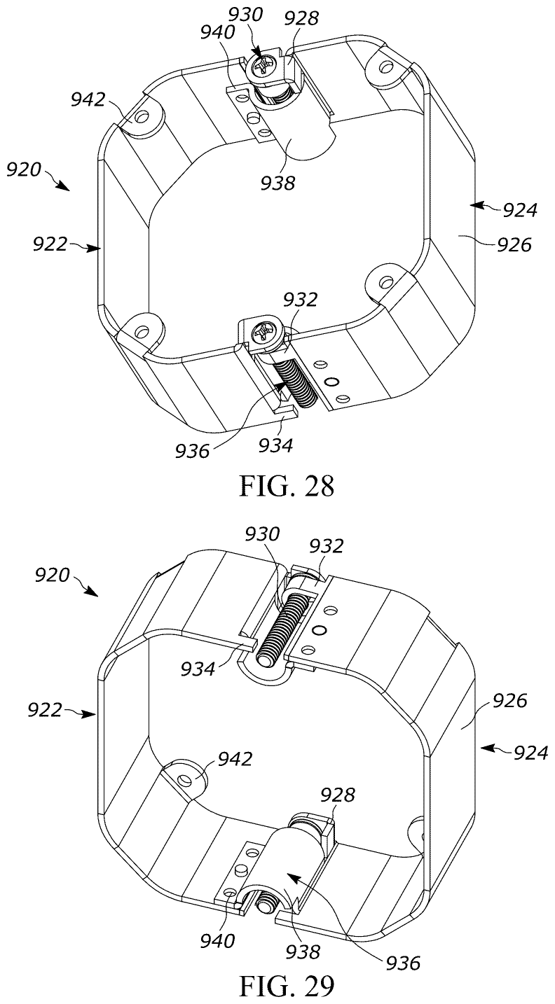

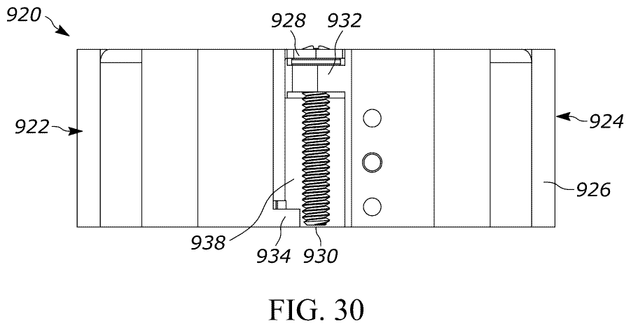

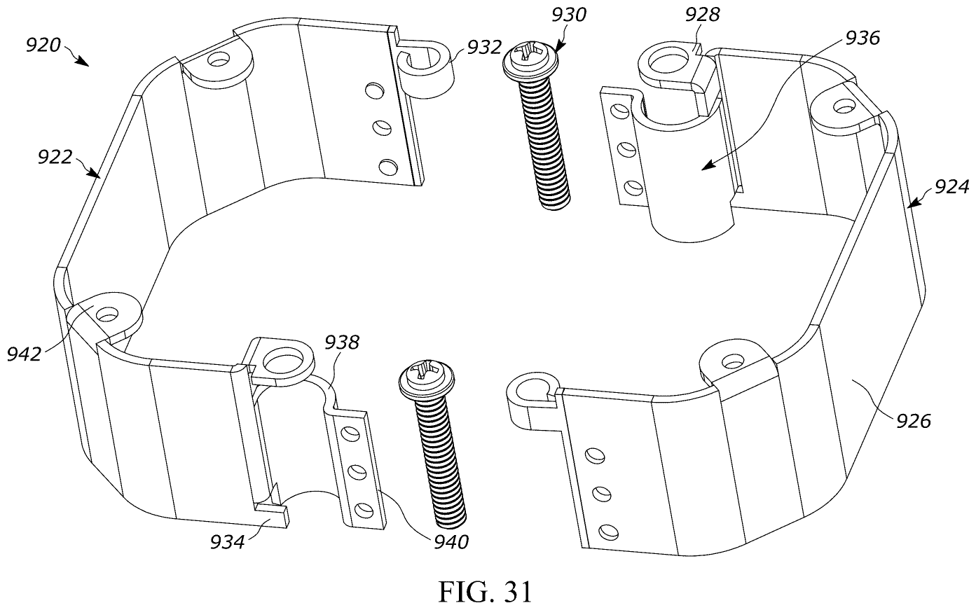

FIGS. 28-31 show an exemplary configuration of the ring 920. The ring 920 is configured to fit inside of the central region of the cover 900 bound by the side walls 908, 910. The size and shape of the ring 920 can therefore be designed to correspond to the cover 900 as needed. The ring 920 is movable in the central region of the cover 900 from a retracted position to an extend position to adjust the depth as needed by a user.

The ring 920 can be made from a single unitary piece or multiple pieces. The illustrated configuration shows the ring 920 having a first ring member 922 and a second ring member 924. The structure of the first and second ring members 922, 924 can be substantially mirror to each other, with common elements described and numbered accordingly herein.

In the illustrated configuration, each of the ring members 922, 924 includes one or more side walls 926. The height of the side walls 926 can be set to provide a desired maximum extension of the ring 920. Each of the ring members 922, 924 includes one or more mounting tabs 928. The mounting tabs 928 can extend outwardly from opposite ends of the side wall 926. Each mounting tab 928 includes an aperture, configured and dimensioned to receive one of the one or more drive members 930 so that the drive member 930 can pass through mounting tab 928 but remain rotatably coupled within the mounting tab aperture.

The mounting tabs 928 are configured to align with the openings on the flanges 912 on the cover 900. In this configuration, the opening in the mounting tabs 928 aligns with the openings on the flanges 912 so that a first drive member 930 can pass through the mounting tab 928 into operative engagement with the flange 912. The drive member 930 can threadably engage the opening on the flange 912 so that rotation of the drive member 930 causes translation of the ring 920 relative to the cover 900.

Each ring member 922, 924 can include a first stop arm 932 provided to stop movement when the ring reaches a retracted position, as shown in FIG. 25. In certain configurations, the stop arm 932 is a hooked shaped or U-shaped member extending from the side wall 926. The stop arm 932 can extend from an upper portion of the side wall 926 and be positioned adjacent the mounting tab 928 so that the stop arm 932 is positioned between the mounting tab 928 of the ring 920 and the flange 912 of the cover. As the ring 920 is being moved to the retracted position by the drive member 930, the mounting tab 928 and stop arm 932 move toward the flange 912. When the stop arm 932 contacts the flange 912, the ring 920 is in the final retracted position.

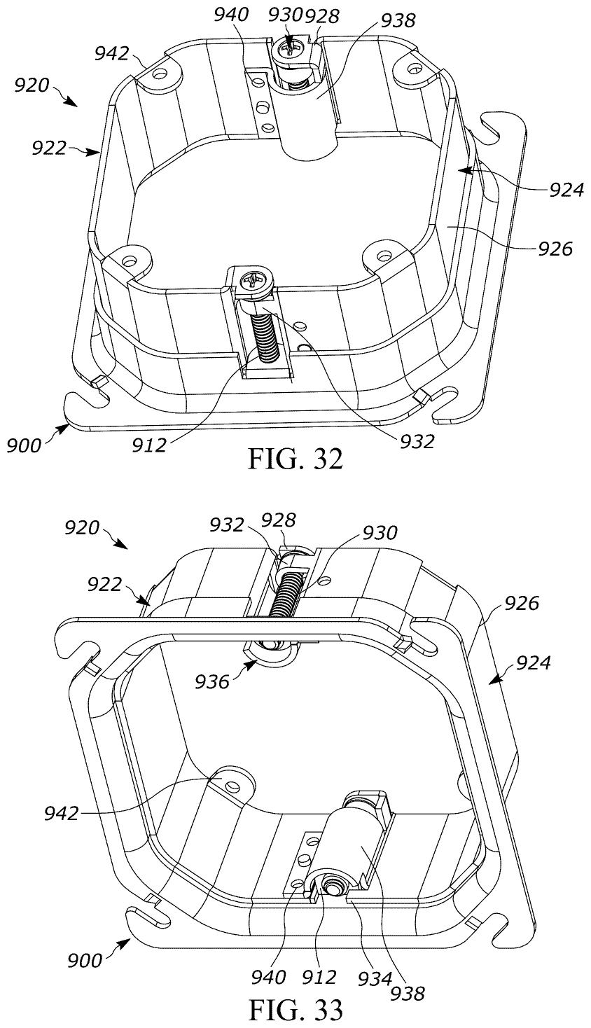

Each ring member 922, 924 can also include a second stop arm 934 to stop movement when the ring 920 reaches a fully extended position, as shown in FIGS. 32 and 33. The second stop arm 934 extends from a bottom portion of the side wall 926 so that the stop arm 934 is positioned to engage a bottom surface of the flange 912. As the ring 920 is moved to the fully extended position by the drive member 930, the stop arm 934 moves toward the flange 912. When the stop arm 934 contacts the flange 912, the ring 920 is in the fully extended position.

The ring 920 can include one or more protective members 936 that are configured to extend around at least a portion of the drive members 930. The protective members 936 can help prevent electrical wires within an electrical box from contacting the drive members 930. In certain configurations, a protective member 936 is positioned around each of the drive members 930.

Each protective member 936 can include a shroud 938 and a base 940. In certain configurations, the base 940 is integral with or monolithically formed into the side wall 926 of the ring 920. In some configurations, the base 940 can secured to the side wall 926 by a fastener such as a rivet or pin, by a joining process such as an adhesive, weld, or solder, or a combination of both.

The ring 920 can also include one or more device mounting tabs 942 used to secure an electrical device to the ring 920. In the illustrated embodiment, the ring 920 includes two pairs of opposing device mounting tabs 942 that extend from a top edge of the side wall 926 into the interior. The device mounting tabs 942 can extend or protrude from the wall 926 so that they are substantially perpendicular to the side wall 926. The device mounting tabs 942 are positioned on opposite sides of the side wall 926.

During installation, an operator can rotate the drive members 930 to thread or unthread the threaded shanks relative to the flanges 912, thus changing the position of the ring 920 relative to the cover 900. In this manner, the operator may adjust the depth of the ring 920 relative to the electrical box 950 between the retracted position and the extended position as necessary to accommodate various wall thicknesses.

The foregoing detailed description of the certain exemplary configurations and implementations has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings.

What is claimed:

1. A cover plate for an electrical box comprising:
a base plate;
a plurality of side walls extending from the base plate and at least partially defining a central opening, the plurality of side walls including a curvilinear wall and a set of opposing rectilinear walls;
a first set of mounting ears extending from the plurality of side walls into the central opening, the first set of mounting ears positioned to receive an electrical device in a first orientation; and
a second set of mounting ears extending from the plurality of side walls into the central opening, the second set of mounting ears positioned to receive an electrical device in a second orientation.

2. The cover plate of claim 1, wherein the base plate has a square configuration.

3. The cover plate of claim 1, wherein the base plate includes a plurality of mounting slots.

4. The cover plate of claim 1, wherein the second set of ears is offset from the first set of ears by approximately 45 degrees.

5. The cover plate of claim 1, wherein the second set of ears is offset from the first set of ears by approximately 90 degrees.

6. The cover plate of claim 1, further comprising a third set of mounting ears offset from the first and second set of mounting ears.

7. The cover plate of claim 6, further comprising a fourth set of mounting ears offset from the first and second set of mounting ears.

8. The cover plate of claim 1, wherein the plurality of side walls includes a second curvilinear wall.

9. A cover plate for an electrical box comprising:
a base plate;
a plurality of side walls extending from the base plate and at least partially defining an interior, the plurality of side walls including a set of opposing curvilinear walls and a set of opposing rectilinear walls; and
a cross brace extending across the interior, the cross brace including a set of outer openings and a central opening.

10. The cover plate of claim 9, wherein the central opening is a threaded aperture.

11. The cover plate of claim 9, wherein the central opening is positioned between the outer openings.

12. A cover plate for an electrical box comprising:
a base plate;
a plurality of side walls extending from the base plate and at least partially defining a central opening, the plurality of side walls including a set of opposing curvilinear walls and a set of opposing rectilinear walls; and
a first set of mounting ears extending from the plurality of side walls into the central opening, the first set of mounting ears positioned to receive an electrical device in a first orientation;
a second set of mounting ears extending from the plurality of side walls into the central opening, the second set of mounting ears positioned to receive an electrical device in a second orientation; and
a masonry bracket connected to at least one of the plurality of side walls.

13. The cover plate of claim 12, wherein the masonry bracket includes a body, a leg extending from the body, a flange extending from the leg, a lower spring member extending form the body, and an upper spring member extending from the body.

14. The cover plate of claim 13, wherein the leg is resilient relative to the body and configured to provide a spring force.

15. The cover plate of claim 13, wherein the lower spring member includes a first wing and a second wing, and wherein each wing includes a first portion extending from the body a second portion extending from the first portion at a downward angle.

16. The cover plate of claim 13, wherein the upper spring member includes a central portion extending substantially perpendicular to the body, a first arm and a second arm, and wherein each arm includes a first portion extending at an angle relative to the central portion.

17. A mud ring assembly for supporting an electrical device, the mud ring assembly comprising:
a cover having a base plate, a plurality of side walls extending from the base plate and at least partially defining a central opening, the plurality of side walls including a set of curvilinear walls and a set of rectilinear walls;
an adjustable ring positioned within the cover and movable within the cover between a retracted position and an extended position; and
a drive member operatively coupled to the cover such that rotation of the drive member causes the adjustable ring to move between the retracted position and the extended position.

18. The mud ring assembly of claim 17, wherein the adjustable ring comprises a first ring member and a second ring member.

19. The mud ring assembly of claim 17, further comprising a protective member configured to extend around at least a portion of the drive member to prevent electrical wires from contacting the drive member.

20. The mud ring assembly of claim 19, wherein the protective member includes a shroud and a base, the base being integral formed into a side wall of the adjustable ring.
